(19) United States
(12) Patent Application Publication
(10) Pub. No.: US 2006/0163350 A1
(43) Pub. Date: Jul. 27, 2006

(54) Managing RFID tags using an RFID-enabled cart

(76) Inventors: Michael N. Melton, Centennial, CO (US); James A. Curry, Lakewood, CO (US); Theodore G. Arnold, Highlands Ranch, CO (US)

Correspondence Address: FISH & RICHARDSON P.C., P.O. BOX 1022, MINNEAPOLIS, MN, 55440-1022, US

(21) Appl. No.: 11/033,328

(22) Filed: Jan. 11, 2005

(51) Int. Cl. G06K 7/00; B60R 7/00; G08B 13/14

(52) U.S. Cl. 235/435; 340/572.8; 340/572.7; 224/411

(57) ABSTRACT

A portable Radio Frequency Identification (RFID) antenna for managing or otherwise processing RFID tagged items using a portable cart. The RFID cart comprises an onboard power source and an RFID antenna operable to communicate with an RFID tag at a distance greater than five feet and powered by the onboard power source. The RFID tag is coupled with an item and the tag communications comprise at least an RFID identifier uniquely identifying the item. The RFID cart further comprises an RFID reader operable to communicate with the RFID antenna and the RFID cart is operable to relocate via a mobile component.

### TECHNICAL FIELD

This disclosure relates generally to the field of Radio Frequency Identification (RFID) and, more specifically, for managing RFID tags using a portable RFID antenna on a cart.

### BACKGROUND

RFID generally encompasses any wireless (or partially wireless) communication that allows for remote retrieval of information associated with a particular commodity, product, component, or other item. In RFID environments, each suitable item is tagged with an RFID tag that includes and (actively or passively) transmits one or more pieces of information including, for example, a unique identifier and such. These pieces of information are requested or retrieved by an RFID reader. Typical RFID readers are either small handheld devices that operate in a limited RFID space or are stationary devices located at, for example, doors, gates, and other non-mobile or fixed sites. The handheld RFID reader generally requires the operator to be within five feet to query the desired RFID tags. Some stationary or fixed mount devices offer relatively greater distance communications, but are also usually larger than the handheld devices. Moreover, the RFID often must be manually docked or interfaced with a port such that the collected RFID information can be processed. In many circumstances, RFID technology allows the two devices (the tag and reader) to communicate with one another while not maintaining a line-of-sight in various weather conditions.

### SUMMARY

This disclosure describes a system and method for managing Radio Frequency Identification (RFID) tags using a portable RFID antenna. For example, a portable cart is operable to manage a plurality of remote RFID tagged items. In this example, the RFID cart comprises an onboard power source and an RFID antenna operable to communicate with an RFID tag at a distance greater than five feet and powered by the onboard power source. The RFID tag is coupled with an item and the tag communications comprise at least an RFID identifier uniquely identifying the item. The RFID cart further comprises an RFID reader operable to communicate with the RFID antenna. Moreover, the RFID cart is operable to relocate via a mobile component such as wheels or tracks.

In another example, the method for managing tagged items using a portable Radio Frequency Identification (RFID) antenna includes positioning an RFID antenna to a first location using a portable cart, with the portable cart comprising an onboard power source operable to power the RFID antenna. A first RFID tag is automatically queried at a distance greater than five feet using the RFID antenna. The first RFID tag coupled with a first item and the tag communications comprise at least a first RFID identifier uniquely identifying the first item. The RFID antenna is then positioned to a second location using the portable cart and automatically queries a second RFID tag at a distance greater than five feet, with the second RFID tag coupled with a second item and the tag communications comprising at least a second RFID identifier uniquely identifying the second item.

In certain embodiments, the RFID cart may further include a local computer, with the computer coupled with the RFID tag reader and at least partially powered by the onboard power device. The local computer may be operable to process the tag communications between the RFID tag reader and the RFID tag. The computer communicably may also be communicably coupled with a remote server via a wireless connection and execute software operable to dynamically filter the tag communications and to communicate the filtered communications to the server. The RFID cart may further include a control switch communicably coupled with the RFID tag reader and operable to enable or disable the RFID tag reader.

The details of various embodiments of the invention are set forth in the accompanying drawings and the description below. One or more embodiments of the invention may include several important technical advantages. For example, the described techniques may allow an inventory of RFID tagged items using a more distant and powerful reader, namely an RFID antenna. This example RFID antenna may be attached to any mobile mechanism that would allow a particular employee or other individual to easily maneuver the antenna through the RFID tagged items. In other words, some or all of the techniques may allow a factory, warehouse, dealership, or other entity or location to easily manage large RFID antennas in a portable manner so that a “walk around” inventory is possible. Of course, certain embodiments of the invention may have none, some or all of these advantages. Other features, objects, and advantages of the invention will be apparent from the description and drawings, as well as from the claims.

### DESCRIPTION OF THE DRAWINGS

FIG. 1 illustrates an example cart, coupled with an RFID antenna.

FIG. 2 is an illustration of an example system operable to manage a plurality of RFID tags using the cart illustrated in FIG. 1; and

FIG. 3 is a flowchart illustrating an example method for managing RFID tags using a portable RFID antenna.

### DESCRIPTION OF EXAMPLE EMBODIMENTS

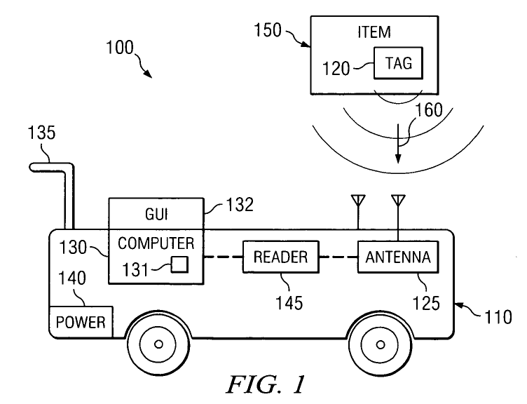

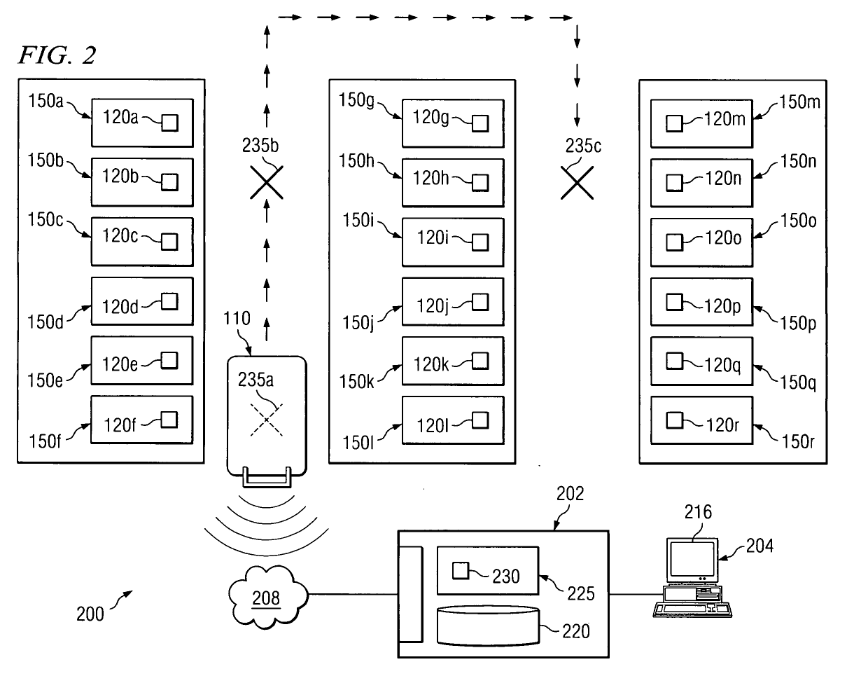

FIG. 1 illustrates a system 100 for managing at least one item 150 using a portable Radio Frequency Identification (RFID) antenna 125. More specifically, system 100 facilities any person or entity using RFID to track, locate, identify, process, filter, or otherwise manage a plurality of items 150 through RFID communications from a greater distance and more efficiently using a portable cart 110 coupled with one or more RFID antennas 125. System 100 comprises all or a portion of any appropriate location including, for example, a shopping center, grocery store, factory, or warehouse (as illustrated in more detail in FIG. 2). These locations may include thousands or even millions of items 150 stored across tens of thousands of square feet. Accordingly, these large locations may be difficult to manually inventory or locate individual items 150. But, of course, system 100 may be of any size or configuration that includes one or more tagged items 150 and accommodates (or is operable to be scanned by) cart 110. For example, illustrated system 100 merely includes cart 110, coupled with at least a relatively high powered or full sized RFID antenna 125, an RFID tag reader 145, and an onboard power source 140, with cart 110 being operable to communicate with RFID tagged items 150.

As used herein, items 150 may each be any component, device, commodity, or other product or article operable to be tagged using RFID tags 120. For example, these items 150 may include computers or other electronics, luggage, groceries, boxes, and/or numerous others. These tagged items 150 are associated with a plurality of electronic characteristics including, for example, serial number, color, size, weight, price, manufacturer, and other identifying (at least among a particular field, industry, or business entity or unit) data using tag information 160. Typically, this tag information 160 is associated with item 150 by being stored or referenced in RFID tag 120.

Item 150 is coupled with RFID tag 120 using any coupling components or techniques. Generally, RFID tag 120 is any component operable to communicate radio signals or other wireless communications that include identifying information 160. RFID tag 120 is typically a small component that may be wired, attached, or otherwise secured to item 150. In certain embodiments, RFID tag 120 may be secured in such a way that removing it will disable tag 120 or activate some other similar security feature.

Moreover, each tag 120 may be of a different size or configuration purchased or customized to match the appropriate item 150. RFID tag 120 may be active or passive as appropriate. The active RFID tag 120 is generally a radio transmitter with a power supply and suitable memory (such as one or more megabytes). This tag 120 usually has ranges of dozens of meters and is in an “always on” state (when powered on). Generally, a passive RFID tag 120 is a smaller device, such as 0.4 millimeters, that does not require a power supply and includes less memory. The requisite power is typically provided by the radio signal, which activates the passive RFID tag 120 when information is requested. Whether active or passive, RFID tag 120 is operable to transmit any suitable radio signal. For example, system 100 may be or include a low frequency system (125-134 kHz), high frequency system (13-14 MHz), a UHF system (850-950 MHz), a microwave system (2.4 GHz), another suitable frequency, or any combination thereof compatible with a particular cart 110 and operable to transmit RFID information 160. This information 160 may be stored in local tag memory or other coupled memory. In other words, RFID tag 120 may automatically supply users of system 100 with electronic information 160 about item 150. This information 160 may include any data that is operable to be dynamically filtered based on certain criteria or parameters. The term “dynamically,” as used herein, generally means that certain processing is determined, at least in part, at run-time based on one or more variables. The term “automatically,” as used herein, generally means that the appropriate processing is substantially performed by at least part of system 100. It should be understood that “automatically” further includes any suitable user interaction with system 100 or cart 110 without departing from the scope of this disclosure.

Cart 110 is any device operable to physically travel or relocate among or around a plurality of items 150 such that a full-size RFID antenna 125 may be considered relatively portable. For example, cart 110 may be a shopping cart, a golf cart, a dolly, a flatbed, a forklift, a robot, an airport shuttle cart, an airport luggage cart, or any other suitable vehicle or mobile mechanism of any appropriate size to accommodate at least one RFID antenna 125. In certain embodiments, cart 110 may be a hand-pushed device or an electronic device operable to automatically relocate according to present commands or algorithms or a dynamically determined path. Cart 110 includes at least one RFID antenna 125, RFID reader 145, and onboard power source 140. Generally power source 140 may be any suitable battery or fuel source operable to (at least partially) drive cart 110 and power RFID antenna 125 and RFID tag reader 145. Illustrated cart 110 also includes on-board computer 130, graphical user interface 132, and a control switch 135 to add additional functionality to cart 110 or for ease or efficiency of the operator; but these components are optional and may not be present in some carts 110.

RFID antenna 125 is any antenna operable to communicate using RFID communications at distances greater than handheld devices. For example, RFID antenna 125 may be 28.25″ long, 12.5″ high, 1.5″ thick, and operable to communicate with RFID tags 120 at distances of greater than five feet. RFID antenna 125 may be coupled with cart 110 using any appropriate technique including bolting to or embedding in cart 110. Moreover, each antenna 125 may be oriented in a particular direction. For example, cart 110 may have a first antenna 125 attached to one side of cart 110 and a second antenna 125 on the other side. This placement would allow the two antennas 125 to be oriented in opposite directions, thereby possibly allowing cart 110 to more efficiently collect tag information 160 at a greater distance. In another example, cart 110 includes four antennas 125, i.e. one for each side. Regardless of the number or orientation, each RFID antenna 125 is part of or communicably coupled with RFID tag reader 145.

Cart 100 uses at least one RFID tag reader 145 for monitoring, querying, or otherwise processing data from RFID antenna 125. RFID tag reader 145 is any device, such as a transceiver, operable to communicate with RFID tags 120 through one or more RFID antennas 125. As described in more detail in FIG. 2, RFID tag reader 145 may also be compatible to communicate, via wireless or wireline signals, with other computers such as onboard or local computer 130 and remote server 202. In certain embodiments, RFID tag reader 145 operates at one frequency compatible with RFID tags 120 or at numerous frequencies to accommodate numerous disparate RFID tags 120, as well as with server 202 (see FIG. 2) for example. RFID tag reader 145 may also include an encoder/decoder or other secured communication device. In certain embodiments, RFID tag reader 145 is communicably coupled with computer 130.

Onboard computer 130 comprises any local processing device (such as a laptop, blade, personal data assistant (PDA), or other) operable to manage, massage, filter, or otherwise process RFID tag information 160. Local computer 130 may be communicably coupled with cart 110 using any appropriate technique. For example, local computer 130 may be a laptop that rests on top of cart 110, a PDA carried by the operator of cart 110, or a processing device embedded within cart 110. In certain embodiments, computer 130 may be wirelessly connected to other computers for subsequent processing or viewing of tag information 160. Moreover, computer 130 may also execute any appropriate off-the-shelf, customized, or proprietary applications. For example, illustrated computer 130 includes local processing engine 131, which comprises any software and/or firmware operable to perform this processing.

Processing engine 131 may be written or described in any appropriate computer language including C, C++, Java, J#, Visual Basic, assembler, Perl, any suitable version of 4GL, and others or any combination thereof. It will be understood that while processing engine 131 is illustrated in FIG. 1 as a single multi-tasked module, the features and functionality performed by this engine may be performed by multiple modules such as i) an Application Level Event (ALE) module operable to filter tag information 160 based on business rules; and ii) other criteria and middleware operable to process the filtered information 160. In certain embodiments, processing engine 131 may also include or be communicably coupled with an onboard database for storing the collected RFID tag information 160. In some of these embodiments, local database may be a relational database comprising one or more tables described in terms of SQL statements or scripts. In other embodiments, the local database may store or define various data structures as text files, eXtensible Markup Language (XML) documents, Virtual Storage Access Method (VSAM) files, flat files, Btrieve files, comma-separated-value (CSV) files, internal variables, or one or more libraries. Further, processing engine 131 may be a child or sub-module of another software module (such as RFID application 230 illustrated in FIG. 2). In certain embodiments, computer 130 also includes or is communicably coupled with GUI 132.

GUI 132 comprises a graphical user interface operable to allow the operator or other user of cart 110 to interface with computer 130 to view information associated with the one or more items 150. Generally, GUI 132 provides the user of cart 110 with an efficient and user-friendly presentation of data, namely information from RFID tags 120. GUI 132 may comprise a plurality of frames or views having interactive fields, pull-down lists, and buttons operated by the user. In one embodiment, GUI 132 communicates one or more web pages presenting information for at least a portion of the queried RFID tags 120. GUI 132 may also present summarized or filtered information 160. It should be understood that the term graphical user interface may be used in the singular or in the plural to describe one or more graphical user interfaces and each of the displays of a particular graphical user interface. Further, GUI 132 can include any graphical user interface (such as a generic web browser, a touch screen, or a text interface), that processes information in system 100 and efficiently presents the information to the operator. In certain embodiments, computer 130 may receive commands from the operator through GUI 132, as well as other input devices (such as a mouse or keyboard).

In one aspect of operation, RFID tag 120 is coupled with item 150 at any suitable time such as, for example, at the time of manufacture or arrival at a warehouse. RFID tag 120 may be secured using screws, welding, adhesive, or through other techniques. Before or after being coupled, RFID tag 120 is encoded or otherwise loaded with certain tag information 160. For example, RFID tag 120 may be programmed with this information using a tag programming station. As described above, this information 160 may include a serial number, an RFID identifier, an inventory number, a SKU, or any other identifying or inventory characteristics. Once sufficiently loaded with certain information 160, then RFID tag 120 is operable to communicate this data to RFID tag reader 145 through RFID antenna 125 in response to or based on queries. For example, an operator may push or direct cart 110 to move among various remote locations to track or inventory tagged items 150 from a distance of five or more feet. In one burst or over a (relative) time period, RFID tag 120 communicates this data 160 to RFID tag reader 145 through portable RFID antenna 125. Using any appropriate technique, RFID tag reader 145 directly or indirectly presents or otherwise communicates this information to the operator or a local program module for viewing or processing. For example, RFID tag reader 145 may present the information through the resident GUI 132, create a report or other output through computer 130, or communicate this information to server 202 (see FIG. 2) for subsequent processing and presentment.

FIG. 2 is a block diagram illustrating at least a portion of item management system 200 for managing one or more RFID tagged items 150. At a high level, item management system 200 is operable to manage, process, or otherwise track a plurality of items 150 based on information retrieved from each vehicle's RFID tag 120 using portable cart 110. In other words, system 200 is any networked, wireless, and/or other RFID-compatible environment and may be or include a store, manufacturing plant, a warehouse, a shipping point, a dealership, and/or other item locations operable to automatically collect and process information from the RFID tags 120. For example, illustrated system 200 is a warehouse comprising a plurality of shelved items 150, one or more RFID-enabled carts 110, and a server 202, client 204, and/or other remote computing device for processing the retrieved information. In this example, items 150 may be stacked in such a way as to make a manual inventory unfeasible or inefficient. Moreover, items 150 may be spread out among thousands or tens of thousands of feet, requiring many man-hours to walk while taking inventory. Continuing this example, the warehouse may provide one or more employees or other personnel with one or more RFID-enabled carts 110 for efficiently processing items 150. Using the cart 110, the operator may push, direct, or command cart 110 to a first location (e.g. location 235a) for querying any items 150 within range of antenna 125. Cart 110 may then move or relocate from location (e.g. location 235b) to location (e.g. location 235c) as desired. Once cart 110 collects any suitable amount of tag information 160, this information may be communicated to server 202 or client 204 for subsequent processing or viewing.

Server 202 comprises any computer and may be communicably connected with any number of clients 204 and/or other network devices such as switches or routers, printers, docking stations, or others. For example, server 202 may be a blade server, a mainframe, a general-purpose personal computer (PC), a Macintosh, a workstation, a Unix-based computer, a web or email server, or any other suitable device. FIG. 2 only illustrates one example of computers that may be used with the invention. For example, although FIG. 1 illustrates one server 202 that may be used with the invention, system 200 can be implemented using computers other than servers, as well as a server pool. Computers other than general purpose computers as well as computers without conventional operating systems can be used. As used in this document, the term “computer” is intended to encompass a personal computer, workstation, network computer, or any other suitable processing device. Computer server 202 may be adapted to execute any operating system including Linux, UNIX, Windows, z/OS, or any other suitable operating system so long as server 202 remains operable to process native or massaged RFID data. Server 202 typically includes an interface for communicating with the other computer systems, such as client 204, over network 208 in a client-server or other distributed environment. Generally, the interface comprises logic encoded in software and/or hardware in a suitable combination and operable to communicate with network 208. More specifically, the interface may comprise software supporting one or more communications protocols associated with communications network 208 or hardware operable to communicate physical signals. In short, server 202 may comprise any computer with software and/or hardware in any combination suitable to receive or retrieve RFID information 160 from RFID tags 120 (via RFID tag reader 145), generate web pages or other output based on the item RFID data 160, and communicate the output to users of one or more clients 204 via network 208.

Network 208 facilitates wireless or wireline communication between computer server 202 and any other computer. Network 208 may communicate, for example, Internet Protocol (IP) packets, Frame Relay frames, Asynchronous Transfer Mode (ATM) cells, voice, video, data, and other suitable information between network addresses. Network 208 may include one or more local area networks (LANs), radio access networks (RANs), metropolitan area networks (MANs), wide area networks (WANs), all or a portion of the global computer network known as the Internet, and/or any other communication system or systems at one or more locations.

Server 202 further includes memory 220 and processor 225. Memory 220 may include any memory or database module and may take the form of volatile or non-volatile memory including, without limitation, magnetic media, optical media, random access memory (RAM), read-only memory (ROM), removable media, or any other suitable local or remote memory component. Memory 220 typically includes collected RFID information 160, but may also include any other suitable data including security logs, web logs, HTML pages and templates, word documents, emails, and others.

Server 202 also includes processor 225. Processor 225 executes instructions and manipulates data to perform the operations of server 202 and may be, for example, a central processing unit (CPU), an application specific integrated circuit (ASIC) or a field-programmable gate array (FPGA). Although FIG. 2 illustrates a single processor 225 in server 202, multiple processors 225 may be used according to particular needs, and reference to processor 225 is meant to include multiple processors 225 where applicable. In certain embodiments, processor 225 executes one or more processes associated with RFID application 230.

RFID application 230 could include any hardware, software, firmware, or combination thereof operable to collect or receive RFID information 160 from carts 110. For example, RFID application 230 may receive RFID information 160, process it according to various algorithms, and store the processed data in memory 220. The processing may include mapping the various tagged items 150 using the RFID technology, embedding information 160 for each tagged item 150 in a webpage, summarizing collected RFID data, and such. RFID application 230 may be written or described in any appropriate computer language including C, C++, Java, J#, Visual Basic, assembler, Perl, any suitable version of 4GL, and others or any combination thereof. It will be understood that while RFID application 230 is illustrated in FIG. 1 as a single multi-tasked module, the features and functionality performed by this engine may be performed by multiple modules. Further, while illustrated as internal to server 202, one or more processes associated with RFID application 230 may be stored, referenced, or executed remotely. Moreover, RFID application 230 may be a child or sub-module of another software module (not illustrated). In one embodiment, RFID application 230 may be referenced by or communicably coupled with applications executing on client 204 or cart 110.

Each client 204 is any computing device operable to present the user with raw or processed RFID information via a graphical user interface 216 (GUI). At a high level, illustrated client 204 includes at least GUI 216 and comprises an electronic computing device operable to receive, transmit, process and store any appropriate data associated with system 200. It will be understood that there may be any number of clients 204 communicably coupled to server 202. Further, the terms “client,” “computer,” and “user” may be used interchangeably. As used in this document, client 204 is intended to encompass a personal computer, workstation, network computer, kiosk, wireless data port, PDA, server, one or more processors within these or other devices, or any other suitable processing device. For example, client 204 may comprise a computer that includes an input device, such as a keypad, touch screen, mouse, or other device that can accept information, and an output device that conveys information associated with the operation of server 202 or clients 102, including digital data or visual information, via GUI 216. Both the input device and output device may include fixed or removable storage media such as a magnetic computer disk, CD-ROM, or other suitable media to both receive input from and provide output to users of clients 102 through GUI 216. Generally, GUI 216 comprises any graphical user interface operable to allow the user of client 204 to interface with system 200 to view information associated with one or more items 150 and/or carts 110. Generally, GUI 216 provides the user of client 204 with an efficient and user-friendly presentation of data provided by system 200, namely information from RFID tags 120. GUI 216 may comprise a plurality of frames or views having interactive fields, pull-down lists, and buttons operated by the user. In one embodiment, GUI 216 communicates one or more web pages presenting information for at least a portion of the queried RFID tags 120. Server 202 can normally accept data from client 204 via the example web browser (e.g., Microsoft Internet Explorer or Netscape Navigator) and return the appropriate HTML or XML responses using network 208.

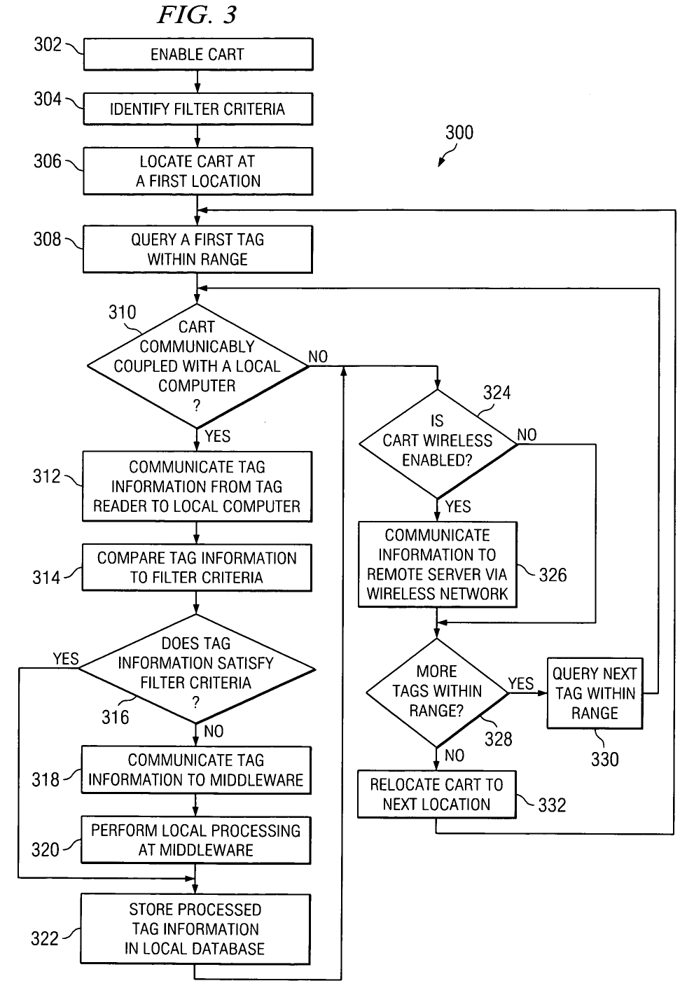

FIG. 3 is a flowchart illustrating an example method 300 for managing RFID tags 120 using a portable RFID antenna 125. Method 300 is described in respect to system 200 and, in particular, to a warehouse including local or remote server 202. However, any other suitable system or portion of a system may use appropriate embodiments of method 500 to retrieve and process RFID information to manage a plurality of RFID tagged vehicles 120. Generally, method 300 describes an operator pushing or directing cart 110 from one location 235 to another such that one or more RFID tags 120 may be queried from a relatively substantial distance.

Example method 300 begins at step 302, when cart 110 is enabled, powered on, or otherwise initialized. For example, the operator may switch a control switch 135 on the handle of cart 110 from off to on. This switch may power on or enable the onboard power source 140, RFID tag reader 145, and/or other components of cart 110. Next, in some embodiments, filter criteria are identified for subsequent filtering of collected tag information 160 at step 304. At step 306, cart 110 is located to a first location 235a. Of course, if cart 110 is already at a desired first location 235a, then the relocation may merely be a confirmation of the location 235. When cart 110 is actually relocated, this movement may be through any technique appropriate for cart 110. For example, the operator may hand-push cart 110 to the desired location 235. In another example, the operator may select a predetermined location using computer 130 and GUI 132. In yet another example, cart 110 may automatically relocate using a predetermined route loaded in computer 130 or may dynamically determine a route based on shelving, sensors, or other obstacles and input.

Once cart 110 is present at the desired location 235, then RFID tag reader 145 queries a first RFID tag 120 within range of RFID antenna 125 at step 308. This query may comprise a request, a retrieval, or any other communication that results in tag information 160 at RFID tag reader 145. If cart 110 is not communicably coupled with computer 130 at decisional step 310, then processing proceeds to step 324. Otherwise, tag information 160 is communicated to local computer 130 at step 312. For example RFID tag reader 145 may transmit the collected information 160 to computer 130 via a wireless or wireline link as appropriate. At step 314, computer 130 (often through local processing engine 131) compares tag information 160 to the filter criteria. If the information satisfies (or fails to satisfy as appropriate) the criteria at decisional step 316, then processing proceeds to step 322. Otherwise, tag information 160 is communicated to example middleware at step 318 for any suitable local processing at step 320. At step 322, the collected or processed information 160 is stored in a local database or other memory or data module.

Next, if cart 100 is wireless enabled at decisional step 324, then cart 110 communicates information 160 to a remote server 202 via the wireless connection at step 326. Next, RFID tag reader 145 or the operator determines if there are more desired RFID tags 120 or tagged items 150 within range of portable RFID antenna 125 at decisional step 328. If there are, then cart 110 queries the next tag 120 within range at step 330. Once there are no more tags 120 within range (and if there are more desired or required items 150 or unprocessed locations 235), then cart 110 relocates to a next location 235 at step 332 and processing returns to step 308.

The preceding flowchart focuses on the operation of example systems 100 and/or 200 described in FIGS. 1 and 2 as these example diagrams illustrate various functional elements that implement some or all of the preceding techniques for managing tagged items using portable RFID antenna 125. However, as noted above, cart 110, systems 100, and/or 200 can use any suitable combination and arrangement of functional elements for providing these operations, and these techniques can be combined with other techniques as appropriate. Further, various changes may be made to the preceding flowcharts. In other words, many of the steps in these flowcharts may take place simultaneously and/or in different orders than as shown. For example, while method 300 describes the steps occurring serially, instead cart 110 may be concurrently moving and querying. In this example, cart 100 may not stop at the particular location 235, but may traverse through it as appropriate. Moreover, these systems may implement methods with additional steps, fewer steps, and/or different steps, so long as the methods remain appropriate.

Although techniques have been described in terms of certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention.

What is claimed is:

1. A Radio Frequency Identification (RFID) cart for managing a plurality of RFID tagged items, the RFID cart comprising:
an onboard power source;
an RFID antenna operable to communicate with an RFID tag at a distance greater than five feet and powered by the onboard power source, the RFID tag coupled with an item and the tag communications comprising at least an RFID identifier uniquely identifying the item;
an RFID tag reader operable to communicate with the RFID antenna; and
the RFID cart operable to relocate using a mobile component.

2. The RFID cart of claim 1, the cart further comprising a local computer, the computer coupled with the RFID tag reader, at least partially powered by the onboard power device, and operable to process the tag communications between the RFID tag reader and the RFID tag.

3. The RFID cart of claim 2, the computer communicably coupled with a remote server via a wireless connection and executing software operable to dynamically filter the tag communications and to communicate the filtered communications to the server.

4. The RFID cart of claim 1, the cart further comprising a control switch communicably coupled with the RFID tag reader, the control switch operable to enable or disable the RFID tag reader.

5. The RFID cart of claim 1, the mobile component comprising at least two wheels.

6. The RFID cart of claim 1, the mobile component comprising at least one track.

7. The RFID cart of claim 1, the RFID antenna comprising a first RFID antenna oriented in a first direction and the cart further comprising a second RFID antenna, the second RFID antenna oriented in a second direction, powered by the onboard power source, and operable to communicate with a second RFID tag coupled with a second item at a distance greater than five feet.

8. The RFID cart of claim 1, the cart comprising a manually driven vehicle.

9. The RFID cart of claim 1, the cart comprising an electronic cart operable to automatically relocate from a first location to a second location.

10. A method for managing tagged items using a portable Radio Frequency Identification (RFID) antenna comprising:
positioning an RFID antenna to a first location using a portable cart, the portable cart comprising an onboard power source operable to power the RFID antenna;
automatically querying a first RFID tag at a distance greater than five feet using the RFID antenna, the first RFID tag coupled with a first item and the tag communications comprising at least a first RFID identifier uniquely identifying the first item;
positioning the RFID antenna to a second location using the portable cart; and
automatically querying a second RFID tag at a distance greater than five feet using the RFID antenna, the second RFID tag coupled with a second item and the tag communications comprising at least a second RFID identifier uniquely identifying the second item.

11. The method of claim 10, wherein positioning the RFID antenna to the first location using the portable cart comprises positioning the RFID antenna to the first location using a tracked cart.

12. The method of claim 10, wherein positioning the RFID antenna to the first location using the portable cart comprises positioning the RFID antenna to the first location using a wheeled cart.

13. The method of claim 10 further comprising disabling further queries of RFID tags through the RFID antenna using a control switch coupled with the RFID cart.

14. The method of claim 10 further comprising automatically communicating the tag communications to a computer, the computer coupled with the RFID cart.

15. The method of claim 14 further comprising:
identifying one or more filter criteria at the computer; and
dynamically filtering the tagged communications based on the filter criteria.

16. The method of claim 15 further comprising wirelessly communicating the filtered communications to a remote server for processing.

17. The method of claim 10, the RFID antenna comprising a first RFID antenna and the method further comprising:
coupling a second RFID antenna to the portable cart;
orienting the first RFID antenna in a first direction;
orienting the second RFID antenna in a second direction; and
automatically querying a third RFID tag at a distance greater than five feet using the second RFID antenna, the third RFID tag coupled with a third item and the tag communications comprising at least a third RFID identifier uniquely identifying the third item.

18. A system for managing tagged items using a portable Radio Frequency Identification (RFID) antenna comprising:
means for positioning an RFID antenna to a first location, the means comprising an onboard power source operable to power the RFID antenna;
means for automatically querying a first RFID tag at a distance greater than five feet using the RFID antenna, the first RFID tag coupled with a first item and the tag communications comprising at least a first RFID identifier uniquely identifying the first item;
the means for positioning the RFID antenna to the first location further operable to position the RFID antenna to a second location; and
the means for automatically querying the first RFID tag further operable to automatically query a second RFID tag at a distance greater than five feet using the RFID antenna, the second RFID tag coupled with a second item and the tag communications comprising at least a second RFID identifier uniquely identifying the second item.

19. The system of claim 18, the means for positioning the RFID antenna to the first location further operable to position a second RFID antenna to the first location and the system further comprising:
means for orienting the first RFID antenna in a first direction at the first location; and
means for orienting the second RFID antenna in a second direction at the first location.

20. The system of claim 18, wherein means for positioning an RFID antenna to a first location comprises wheeled means for positioning an RFID antenna to a first location.
